(19) United States
(12) Patent Application Publication
(10) Pub. No.: US 2026/0028032 A1
(43) Pub. Date: Jan. 29, 2026

(54) VEHICLE OPERATION

(71) Applicant: Ford Global Technologies, LLC, Dearborn, MI (US)

(72) Inventors: Yifei Li, Shanghai (CN); Heng Fan, Shanghai (CN); Kunpeng Gao, Songjang/Shanghai (CN)

(73) Assignee: Ford Global Technologies, LLC, Dearborn, MI (US)

(21) Appl. No.: 18/783,526

(22) Filed: Jul. 25, 2024

(51) Int. Cl. B60W 50/00; G01C 21/00; G06F 16/29

(52) U.S. Cl. CPC B60W 50/0097; G01C 21/3841; G06F 16/29; B60W 2050/0052; B60W 2520/06; B60W 2554/4044; B60W 2555/60; B60W 2556/40

(57) ABSTRACT

A portion of an occupancy grid for an area is obtained. The occupancy grid map is generated based on collected data of a host object in the area and collected data of respective target objects in the area. A predicted portion occupancy grid for the area is generated based on predicted data of the host object and predicted data of the respective target objects. An action is determined based on inputting the portion and the predicted portion of the occupancy grid to a deep reinforcement learning neural network. A host object is operated based on the action.

### BACKGROUND

Computers can operate systems and devices including vehicles, robots, drones, and/or object tracking systems. Data regarding the system's environment can be acquired by sensors and processed by a computer that can operate the system or at least some components thereof based on the data, including making real-time decisions based on the data. For example, the sensors can provide data concerning paths to be traveled and objects to be accounted for in the system's environment.

### BRIEF DESCRIPTION OF THE DRAWINGS

FIG. 1 is a block diagram illustrating an example vehicle control system.

FIG. 2A is a diagram illustrating an example region area in which the system of FIG. 1 would be implemented.

FIG. 2B is a diagram illustrating an example area within the region of FIG. 2 at which the system of FIG. 1 would be implemented.

FIG. 3A is an exemplary occupancy grid map of a portion of FIG. 2A.

FIG. 3B is an exemplary portion of the occupancy grid map in FIG. 3A.

FIG. 3C is an exemplary predicted portion of the occupancy grid map of FIG. 3A.

FIG. 4 is a block diagram illustrating an example prediction system.

FIG. 5 is a block diagram illustrating an example deep reinforcement learning (DRL) agent.

FIG. 6 is a block diagram illustrating an example simulation system to train the DRL agent.

FIG. 7 an example flowchart of an example process for operating a vehicle.

FIG. 8 is an example flowchart of an example process for training the DRL agent.

### DETAILED DESCRIPTION

Systems that move and/or that have mobile or movable components, including vehicles, robots, drones, cell phones etc., can be operated by acquiring sensor data, including data regarding an environment around the system, and processing the sensor data to determine locations of objects in the environment around the system. The determined location data could be processed to determine operation of the system or portions of the system. For example, a robot could determine the location of another nearby robot's arm. The determined robot arm location could be used by the robot to determine a path upon which to move a gripper to grasp a workpiece without encountering the other robot's arm. In another example, a vehicle could determine a location of another vehicle traveling on a roadway. The vehicle could use the determined location of the other vehicle to determine a path upon which to operate while maintaining a predetermined distance from the other vehicle. A vehicle will be used herein as a non-limiting example of a system that moves and/or has moveable components in description below.

A vehicle can include a system that may control various vehicle components and/or operations without input from a human operator. For example, the vehicle system may perform perception, motion planning, and motion control to operate the vehicle in an environment around the vehicle. Perception may obtain information about the vehicle, its surrounding environment, and objects therein based on sensor data. For example, the perception may collect vehicle sensor data and may receive remote sensor data from other vehicles (e.g., via vehicle-to-vehicle (V2V) communications) and/or from infrastructure (e.g., via vehicle-to-infrastructure (V2I) communications). Motion planning is a process by which a path is determined to operate a vehicle within an environment while accounting for objects in the environment. Motion planning operation can take as input the sensor data obtained by perception operations. Motion planning operation may plan a path for the vehicle based on the sensor data. Motion control is a process by which the vehicle is operated to move according to the planned plan. Motion control can take the planned path as its input. Motion control can actuate various vehicle components to operate the vehicle along the planned path. Processing sensor data from multiple sources can consume computational resources causing inefficiencies and/or bottlenecks in processing, and can increase an amount of time required to make predictive decisions to navigate the vehicle through the environment while accounting for other objects in the environment.

A system includes a computer including a processor and a memory, the memory storing instructions executable by the processor to obtain a portion of an occupancy grid map for an area. The occupancy grid map is generated based on collected data of a host object in the area and collected data of respective target objects in the area. The instructions further include instructions to generate a predicted portion of the occupancy grid map based on predicted data of the host object and predicted data of the respective target objects. The instructions further include instructions to determine an action based on inputting the portion and the predicted portion of the occupancy grid map to a deep reinforcement learning neural network. The instructions further include instructions to operate the host object based on the action.

The instructions can further include instructions to receive the collected data of the respective target objects from an infrastructure element in the area.

The instructions can further include instructions to determine the collected data of the host object based on host object sensor data.

The deep reinforcement learning neural network may be trained based on a reward function. A reward for the reward function may be determined based on comparing the action to a virtual scenario.

The virtual scenario may include virtual target vehicles operating in a virtual area, simulated signal phase and timing (SPaT) data for virtual traffic signals in the virtual area and map data for the virtual area.

The instructions can further include instructions to, upon inputting the collected data of the host object and respective motion models to an Immediate Unscented Kalman Filter, determine respective object positions for the respective motion models. The instructions can further include instructions to determine a predicted host object position based on output from an Immediate Multiple Model that accepts the respective object positions for the respective motion models as input. The instructions can further include instructions to determine, in the predicted occupancy grid map, a predicted occupancy of the host object based on the predicted host object position and a host object size.

The instructions can further include instructions to, upon determining a predicted heading angle of the host object based on the predicted host object position, determine the predicted occupancy of the host object additionally based on the predicted heading angle.

The instructions can further include instructions to, upon inputting the collected data of each of the respective target objects and respective motion models to an Immediate Unscented Kalman Filter, determine respective target object positions for the respective motion models. The instructions can further include instructions to, for each of the respective target objects, determine a predicted target object position based on output from an Immediate Multiple Model that accepts the respective target object positions for the respective motion models as input. The instructions can further include instructions to determine, in the predicted occupancy grid map, respective predicted occupancies of the respective target objects based on the respective predicted target object positions and respective target object sizes.

The instructions can further include instructions to, upon determining respective predicted heading angles for each of the respective target objects based on the respective predicted target object positions, predicted occupancy of the respective target objects additionally based on the respective predicted heading angles.

The occupancy grid map may be generated based additionally on at least one of signal phase and timing (SPaT) data for traffic signals in the area and map data for the area.

A method includes obtaining a portion of an occupancy grid map for an area. The occupancy grid map is generated based on collected data of a host object in the area and collected data of respective target objects in the area. The method further includes generating a predicted portion of the occupancy grid map based on predicted data of the host object and predicted data of the respective target objects. The method further includes determining an action based on inputting the portion and the predicted portion of the occupancy grid map to a deep reinforcement learning neural network. The method further includes operating the host object based on the action.

The method can further include receiving the collected data of the respective target objects from an infrastructure element in the area.

The method can further include determining the collected data of the host object based on host object sensor data.

The deep reinforcement learning neural network may be trained based on a reward function, a reward for the reward function being determined based on comparing the action to a virtual scenario.

The virtual scenario may include virtual target vehicles operating in a virtual area, simulated signal phase and timing (SPaT) data for virtual traffic signals in the virtual area and map data for the virtual area.

The method can further include, upon inputting the collected data of the host object and respective motion models to an Immediate Unscented Kalman Filter, determining respective object positions for the respective motion models. The method can further include determining a predicted host object position based on output from an Immediate Multiple Model that accepts the respective object positions for the respective motion models as input. The method can further include determining, in the predicted occupancy grid map, a predicted occupancy of the host object based on the predicted host object position and a host object size.

The method can further include, upon determining a predicted heading angle of the host object based on the predicted host object position, determining the predicted occupancy of the host object additionally based on the predicted heading angle.

The method can further include, upon inputting the collected data of each of the respective target objects and respective motion models to an Immediate Unscented Kalman Filter, determining respective target object positions for the respective motion models. The method can further include, for each of the respective target objects, determining a predicted target object position based on output from an Immediate Multiple Model that accepts the respective target object positions for the respective motion models as input. The method can further include determining, in the predicted occupancy grid map, respective predicted occupancies of the respective target objects based on the respective predicted target object positions and respective target object sizes.

The method can further include, upon determining respective predicted heading angles for each of the respective target objects based on the respective predicted target object positions, determining the predicted occupancy of the respective target objects additionally based on the respective predicted heading angles.

The occupancy grid map may be generated based additionally on at least one of signal phase and timing (SPaT) data for traffic signals in the area and map data for the area.

Further disclosed herein is a computing device programmed to execute any of the above method steps. Yet further disclosed herein is a computer program product, including a computer readable medium storing instructions executable by a computer processor, to execute an of the above method steps.

As disclosed herein, a computer can input a portion of an occupancy grid for an area and a predicted portion of the occupancy grid for the area into a deep reinforcement learning neural network that outputs an action for the vehicle. The computer can then operate the vehicle based on the action. Using the deep reinforcement learning neural network to output the action facilitates model learning by evaluating the output action through a reward function, which can conserve computational resources and reduce an amount of time required to make predictive decisions to navigate the vehicle through the environment while accounting for other objects in the environment.

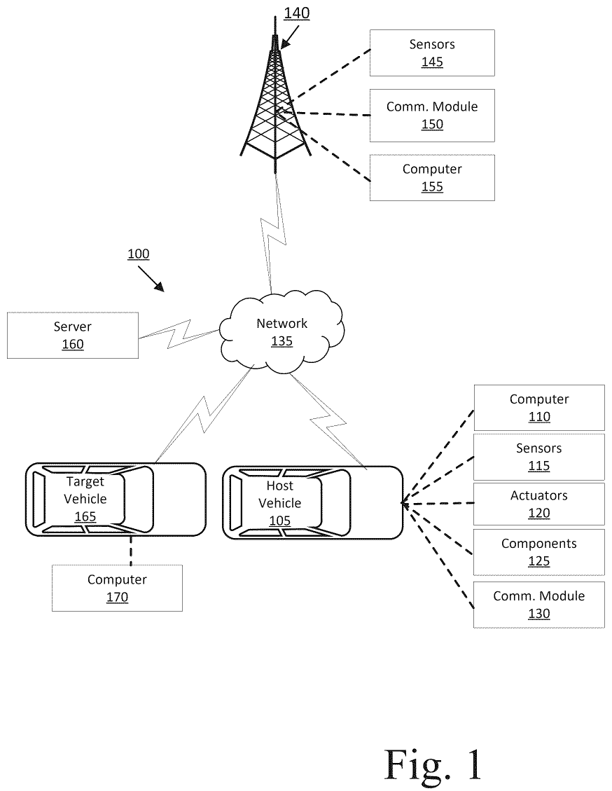

With reference to FIGS. 1-4, an example vehicle control system 100 includes a host vehicle 105. A vehicle computer 110 in the host vehicle 105 receives data from sensors 115. The vehicle computer 110 is programmed to obtain a portion 305 of an occupancy grid map 300 for an area 205. The occupancy grid map 300 is generated based on collected data of the host vehicle 105 in the area 205 and collected data of respective target vehicles 165 in the area 205. The vehicle computer 110 is further programmed to generate a predicted portion 305′ of the occupancy grid map 300 for the area 205 based on predicted data of the host vehicle 105 and predicted data of the respective target vehicles 165. The vehicle computer 110 is further programmed to determine an action 512 based on inputting the portion 305 and the predicted portion 305′ of the occupancy grid map 300 to a deep reinforcement learning (DRL) agent 500. The vehicle computer 110 is further programmed to operate the host vehicle 105 based on the action 512.

DRL is a machine learning technique that uses a deep neural network to approximate a Markov decision process (MDP). An MDP is a discrete-time stochastic control process that models system behavior using a plurality of states, actions, and rewards. An MDP includes one or more states that summarize the current values of variables included in the MDP. At any given time, an MDP is in one and only one state. An action 512 is an input to a state that results in a transition to another state included in the MDP. Each transition from one state to another state (including the same state) is accompanied by an output reward function. A policy is a mapping from the state space (a collection of possible states) to the action space (a collection of possible actions), including reward functions. The DRL agent 500 is a machine learning software program that can use deep reinforcement learning to determine actions that result in maximizing reward functions for a system that can be modeled as an MDP (as discussed further below).

Turning now to FIG. 1, the host vehicle 105 includes the vehicle computer 110, sensors 115, actuators 120 to actuate various vehicle components 125, and a vehicle communications module 130. The communications module 130 allows the vehicle computer 110 to communicate with a remote server computer 160, and/or other vehicles (e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135).

The vehicle computer 110 includes a processor and a memory such as are known. The memory includes one or more forms of computer-readable media, and stores instructions executable by the vehicle computer 110 for performing various operations, including as disclosed herein. The vehicle computer 110 can further include two or more computing devices operating in concert to carry out vehicle 105 operations including as described herein. Further, the vehicle computer 110 can be a generic computer with a processor and memory as described above, and/or may include an electronic control unit (ECU) or electronic controller or the like for a specific function or set of functions, and/or may include a dedicated electronic circuit including an ASIC that is manufactured for a particular operation (e.g., an ASIC for processing sensor data and/or communicating the sensor data). In another example, the vehicle computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming (e.g. stored in a memory electrically connected to the FPGA circuit). In some examples, a combination of processor(s), ASIC(s), and/or FPGA circuits may be included in the vehicle computer 110.

The vehicle computer 110 may include programming to operate one or more of vehicle 105 propulsion, steering, transmission, climate control, interior and/or exterior lights, horn, doors, etc., as well as to determine whether and when the vehicle computer 110, as opposed to a human operator, is to control such operations.

The vehicle computer 110 may include or be communicatively coupled to (e.g., via a vehicle communications network such as a communications bus as described further below) more than one processor (e.g., included in electronic controller units (ECUs) or the like included in the host vehicle 105) for monitoring and/or controlling various vehicle components 125 (e.g., a transmission controller, a steering controller, etc.). The vehicle computer 110 is generally arranged for communications on a vehicle communication network that can include a bus in the host vehicle 105 such as a controller area network (CAN) or the like, and/or other wired and/or wireless mechanisms.

Via the host vehicle 105 network, the vehicle computer 110 may transmit messages to various devices in the host vehicle 105 and/or receive messages (e.g., CAN messages) from the various devices (e.g., sensors 115, an actuator 120, ECUs, etc.). Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known to provide data to the vehicle computer 110. For example, the sensors 115 may include Light Detection And Ranging (LIDAR) sensor(s) 115, etc., disposed on a top of the host vehicle 105, behind a vehicle 105 front windshield, around the host vehicle 105, etc., that provide relative locations, sizes, and shapes of objects surrounding the host vehicle 105. As another example, one or more radar sensors 115 fixed to vehicle 105 bumpers may provide data to provide locations of the objects, second vehicles, etc., relative to the location of the host vehicle 105. The sensors 115 may further alternatively or additionally, for example, include camera sensor(s) 115 (e.g. front view, side view, etc.) providing images from an area surrounding the host vehicle 105. In the context of this disclosure, an object is a physical (i.e., material) item that has mass and that can be represented by physical phenomena (e.g., light or other electromagnetic waves, or sound, etc.) detectable by sensors 115. Thus, the host vehicle 105, as well as other items including as discussed below, fall within the definition of “object” herein.

The vehicle computer 110 is programmed to receive data from one or more sensors 115 substantially continuously, periodically, and/or when instructed by a remote server computer 160, etc. The data may, for example, include a location of the host vehicle 105. Location data specifies a point or points on a ground surface and may be in a known form (e.g., geo-coordinates such as latitude and longitude coordinates obtained via a navigation system, as is known, that uses the Global Positioning System (GPS)). Additionally, or alternatively, the data can include a location of an object (e.g., a vehicle, a sign, a tree, etc.) relative to the host vehicle 105. As one example, the data may be image data of the environment around the host vehicle 105. In such an example, the image data may include one or more objects and/or markings (e.g., lane markings) on or along a road. Image data herein means digital image data (e.g., comprising pixels with intensity and color values) that can be acquired by camera sensors 115. The sensors 115 can be mounted to any suitable location in or on the host vehicle 105 (e.g., on a vehicle 105 bumper, on a top of a vehicle 105, etc.) to collect images of the environment around the host vehicle 105.

The host vehicle 105 actuators 120 are implemented via circuits, chips, or other electronic and or mechanical components that can actuate various vehicle subsystems in accordance with appropriate control signals as is known. The actuators 120 may be used to control components 125, including propulsion and steering of a vehicle 105.

In the context of the present disclosure, a vehicle component 125 is one or more hardware components adapted to perform a mechanical or electro-mechanical function or operation-such as moving the host vehicle 105, slowing or stopping the host vehicle 105, steering the host vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a park assist component, an adaptive cruise control component, an adaptive steering component, etc.

In addition, the vehicle computer 110 may be configured for communicating via a vehicle-to-vehicle communication module 130 or interface with devices outside of the host vehicle 105 (e.g., through a vehicle-to-vehicle (V2V) or vehicle-to-infrastructure (V2X) wireless communications (cellular and/or short-range radio communications, etc.) to another vehicle, and/or to a remote server computer 160 (typically via direct radio frequency communications)). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth, IEEE 802.11, dedicated short range communications (DSRC), cellular V2X (CV2X), and/or wide area networks (WAN), including the Internet, providing data communication services. The label “V2X” is used herein for communications that may be vehicle-to-vehicle (V2V) and/or vehicle-to-infrastructure (V2I), and that may be provided by communication module 130 according to any suitable short-range communications mechanism (e.g., DSRC, cellular, or the like).

The network 135 represents one or more mechanisms by which a vehicle computer 110 may communicate with remote computing devices (e.g., the remote server computer 160, another vehicle computer, etc.). Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

An infrastructure element 140 includes a physical structure such as a tower or other support structure (e.g., a pole, a box mountable to a bridge support, cell phone tower, road sign support, etc.) on or in which infrastructure sensors 145, as well as an infrastructure communications module 150 and computer 155 can be housed, mounted, stored, and/or contained, and powered, etc. One infrastructure element 140 is shown in FIG. 1 for case of illustration, but the system 100 could and likely would include tens, hundreds, or thousands of infrastructure elements 140.

An infrastructure element 140 is typically stationary (i.e., fixed to and not able to move from a specific physical location). The infrastructure sensors 145 may include one or more sensors such as described above for the host vehicle 105 sensors 115 (e.g., LIDAR, radar, cameras, ultrasonic sensors, etc.). The infrastructure sensors 145 are fixed or stationary. That is, each infrastructure sensor 145 is mounted to the infrastructure element 140 so as to have a substantially unmoving and unchanging field of view.

Infrastructure sensors 145 thus provide field of views in contrast to vehicle 105 sensors 115 in a number of advantageous respects. First, because infrastructure sensors 145 have a substantially constant field of view, determinations of vehicle 105 and object locations can be accomplished with fewer and simpler processing resources than if movement of the infrastructure sensors 145 also had to be accounted for. Further, the infrastructure sensors 145 include an external perspective of the host vehicle 105 and can sometimes detect features and characteristics of objects not in the host vehicle 105 sensors 115 field(s) of view and/or can provide more accurate detection (e.g., with respect to vehicle 105 location and/or movement with respect to other objects). Yet further, infrastructure sensors 145 can communicate with the infrastructure element 140 computer 155 via a wired connection, whereas vehicles 105 typically can communicates with infrastructure elements 140 only wirelessly, or only at very limited times when a wired connection is available. Wired communications are more reliable and can be faster than wireless communications such as vehicle-to-infrastructure communications or the like.

The communications module 150 and computer 155 typically have features in common with the vehicle computer 110 and vehicle communications module 130, and therefore will not be described further to prevent redundancy. Although not shown for case of illustration, the infrastructure element 140 also includes a power source such as a battery, solar power cells, and/or a connection to a power grid.

The remote server computer 160 can be a conventional computing device (i.e., including one or more processors and one or more memories) programmed to provide operations such as disclosed herein. Further, the remote server computer 160 can be accessed via the network 135 (e.g., the Internet, a cellular network, and/or or some other wide area network).

A target vehicle 165 may include a computer 170. The computer 170 includes a second processor and a second memory such as are known. The second memory includes one or more forms of computer-readable media, and stores instructions executable by the computer 170 for performing various operations, including as disclosed herein.

Additionally, the target vehicle 165 may include sensors, actuators to actuate various vehicle components, and a vehicle communications module. The sensors, actuators to actuate various vehicle components, and the vehicle communications module typically have features in common with the sensors 115, actuators 120 to actuate various host vehicle components 125, and the vehicle communications module 130, and therefore will not be described further to prevent redundancy.

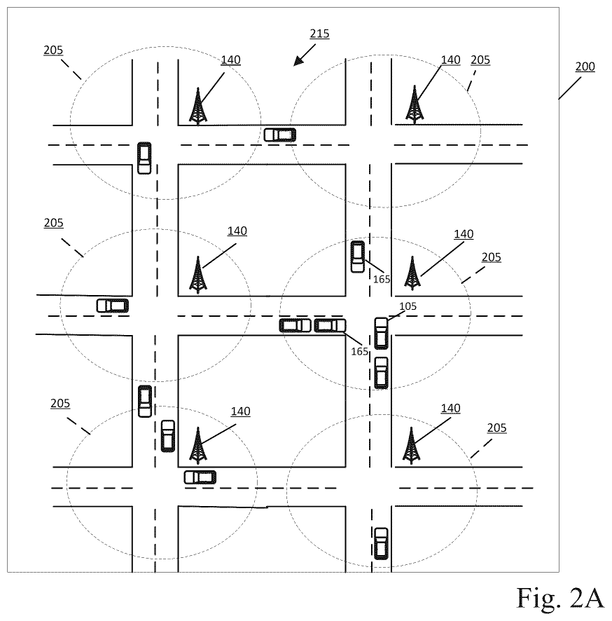

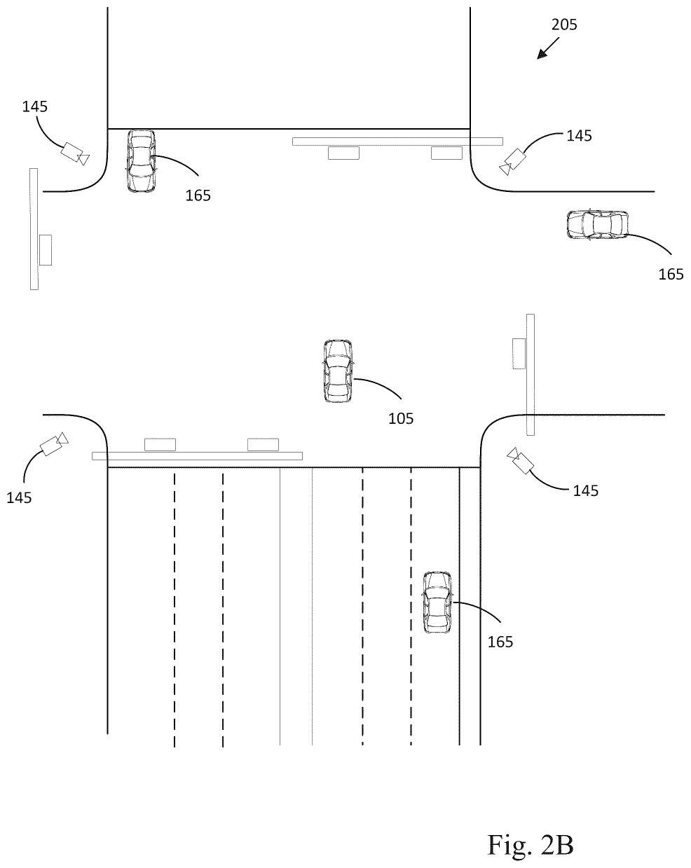

FIG. 2A is a diagram illustrating an example region 200. A region 200 is defined for an infrastructure 215. The infrastructure 215 includes a plurality of infrastructure elements 140 that can be in communication with each other (e.g., via the network 135). The plurality of infrastructure elements 140 are provided to monitor the region 200 around the infrastructure elements 140, as shown in FIG. 2A. The region 200 may be, for example, a neighborhood, a district, a city, a county, etc., or some portion thereof. The region 200 could alternatively be an area defined by a radius encircling the plurality of infrastructure elements 140 or some other distance or set of distances relative to the plurality of infrastructure elements 140.

In addition to vehicles 105, a region 200 can include other objects (e.g., a bicycle object, a pole object etc.) (i.e., a region 200 could alternatively or additionally include many other objects (e.g., bumps, potholes, curbs, berms, fallen trees, litter, construction barriers or cones, etc.). Objects can be specified as being located according to a coordinate system for an area maintained by the remote server computer 160 and/or the infrastructure computer 155 (e.g., according to a Cartesian coordinate system or the like specifying coordinates in the region 200). Additionally, data about an object could specify characteristics of an object in a sub-region such as on or near a road (e.g., a height, a width, etc.).

The region 200 includes one or more roads (not numbered) each having one or more lanes (not numbered). A lane is a specified area of the road for vehicle travel. A road in the present context is an area of ground surface that includes any surface provided for land vehicle travel. A lane of a road is an area defined along a length of a road, typically having a width to accommodate only one vehicle (i.e., such that multiple vehicles can travel in a lane one in front of the other), but not abreast of (i.e., laterally adjacent) one another.

The region 200 includes one or more areas 205, as shown in FIG. 2A. The infrastructure elements 140 in the region 200 are provided to monitor respective areas 205. Each area 205 is a subset that is an area of interest or focus for a particular traffic analysis (e.g., an intersection, a school zone, a railroad crossing, a construction zone, a crosswalk, etc.) in the region 200, as shown in FIG. 2B. An area 205 is proximate to a respective infrastructure element 140. In the present context, “proximate” means that the area 205 is defined by a field of view of the infrastructure element 140 sensor 145. The area 205 could alternatively be an area defined by a radius around the respective infrastructure element 140 or some other distance or set of distances relative to the respective infrastructure element 140.

The infrastructure computer 155 (or the remote server computer 160) can determine collected data of target vehicles 165 in the area 205. In this context, “collected data” are data describing movement and positions of vehicles relative to each other (i.e., collected data are data measuring various vehicle attributes as the vehicle operates in the area). The collected data can be obtained or derived (e.g., according to known data processing techniques) from sensor 115, 145 data. The collected data can include, for example, vehicle speed data, vehicle acceleration data, vehicle braking data, vehicle turning data, vehicle heading angle, etc. That is, as vehicles operate in the area 205, the collected data provide measurements describing how the vehicles operate in the area 205.

The computer 155, 160 can determine the collected data of the target vehicles 165 based on infrastructure sensor 145 data. For example, the infrastructure sensor 145 can capture data, e.g., image and/or video data, of the area 205 and transmit the data to the infrastructure computer 155. Video data can be in digital format and encoded according to conventional compression and/or encoding techniques, providing a sequence of frames of image data where each frame can have a different index and/or represent a specified period of time, e.g., 10 frames per second, and arranged in a sequence. The infrastructure computer 155 can then, for example, analyze the infrastructure sensor 145 data (e.g., using pattern recognition and/or image analysis techniques) to determine the collected data of the target vehicles 165 in the area 205. The infrastructure computer 155 can be programmed to transmit the collected data of the target vehicles 165 to the remote server computer 160 (e.g., via the network 135). As another example, the infrastructure computer 155 can provide the infrastructure sensor 145 data to the remote server computer 160 (e.g., via the network 135) and the remote server computer 160 can analyze the infrastructure sensor 145 data (e.g., using pattern recognition and/or image analysis techniques) to determine the collected data of the target vehicles 165 in the area 205.

Additionally, or alternatively, the computer 155, 160 can determine the collected data of the target vehicles 165 based on signal phase and timing (SPaT) data for traffic signals in the area 205. For example, the traffic signals may control traffic moving through the area 205 based on the SPaT data. SPaT data indicates a timing of a change of the traffic signals from a current state to a next state. Changing states in this context means changing priorities for vehicles travelling through the area 205, such as, for example, changing a first light signal for a first direction of travel from green to red (reducing the priority for travel in the first direction), and changing the light signal for a second direction of travel from red to green (increasing the priority for travel in the second direction). Said differently, SPAT data indicates which light signal is currently energized and an amount of time until the light signal will no longer be energized and another light signal will be energized. The infrastructure computer 155 can store the SPAT data for the traffic signals (e.g., in a memory of the infrastructure computer 155). In such an example, the infrastructure computer 145 can provide the SPAT data to the remote server computer 160. As another example, the remote server computer 160 can store the SPAT data for the traffic signals (e.g., in a memory of the remote server computer 160).

Additionally, or alternatively, the computer 155, 160 can determine the collected data of the target vehicles 165 based on aggregated data. Aggregated data in this context means data from a plurality of vehicle computers 110 that provide messages that is combined arithmetically and/or mathematically (e.g., by averaging and/or using some other statistical measure). That is, the computer 155, 160 may be programmed to receive messages from a plurality of computers 170 indicating collected data of the respective target vehicles 165 (e.g., determined based on vehicle 105 sensor 115 data). Based on the aggregated data indicating the collected data of the target vehicles 165 in the area 205 (e.g., an average number of messages, a percentage of messages, etc., indicating the collected data), and taking advantage of the fact that messages from different target vehicles 165 are provided independently of one another, The computer 155, 160 can determine the collected data of the target vehicles 165 based on the aggregated data. The computer 155, 160 can then transmit the collected data to a plurality of vehicles, including the host vehicle 105 (e.g., via the network 135).

The computer 155, 160 may store (e.g., in a memory thereof) map data for the are 205. The map data can, for example, specify a perimeter of the area 205 (i.e., a geo-fence). A geo-fence herein has the conventional meaning of a boundary for an area defined by sets of geo-coordinates. Additionally, the map data can, for example, specify respective perimeters of respective roads and/or lanes (i.e., respective geo-fences) in the area 205. The map data can include road sign data (i.e., data specifying locations of road signs within the area 205). The map data can include further include a traffic density (a number of vehicles per unit distance along a length of a road) for roads in the area 205. The computer 155, 160 can provide the map data to the vehicle computer 110 (e.g., via the network 135).

The map data can further include operating parameters for vehicles (e.g., the host vehicle 105, the target vehicle 165, etc.) operating in the area 205. An operating parameter herein is a physical limit of vehicle 105, 165 operation, i.e., an operating parameter specifies a limit of a measurement of vehicle operation and/or a measurement of an environmental condition limiting vehicle 105, 165 operation. Put another way, an operating parameter is a limit of a measurement of a physical characteristic of a vehicle 105, 165 or an environment around that vehicle 105, 165 while the vehicle 105, 165 operates in the area 205. A variety of operating parameters may be determined for vehicle operation. A non-limiting list of operating parameters includes a maximum velocity of vehicles 105, 165, travel direction of a lane or road, a location for stopping vehicles 105, 165 prior to entering an intersection when a traffic signal light is red, a minimum distance between vehicles 105, 165 operating on a road, etc.

The computer 155, 160 can receive collected data of the host vehicle 105. For example, the vehicle computer 110 can determine the collected data of the host vehicle 105 (as described further below) and can then transmit the collected data of the host vehicle 105 to the computer 155, 160 (e.g., via the network 135). In such an example, the computer 155, 160 can transform the collected data of the host vehicle 105 from a vehicle coordinate system (e.g., a Cartesian coordinate system having an origin O at a center of gravity of the host vehicle 105) to a global coordinate system (e.g., according to known coordinate system transformation techniques). Alternatively, the computer 155, 160 can determine the collected data of the host vehicle 105 in a same manner as described above regarding determining the collected data of the respective target vehicles 165.

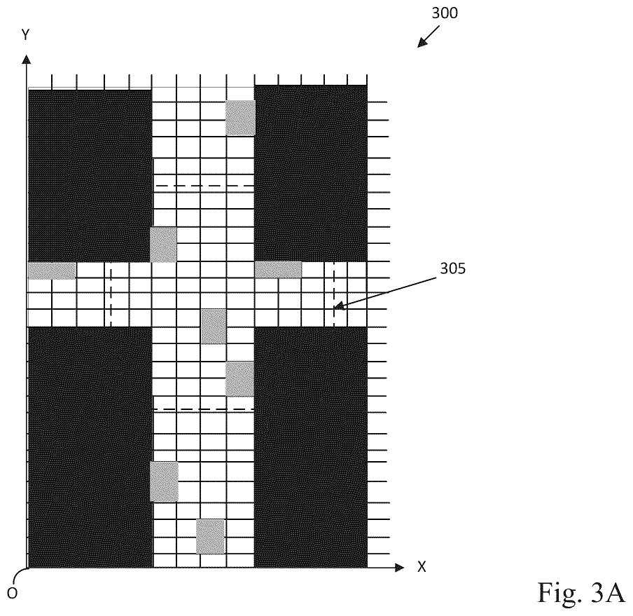

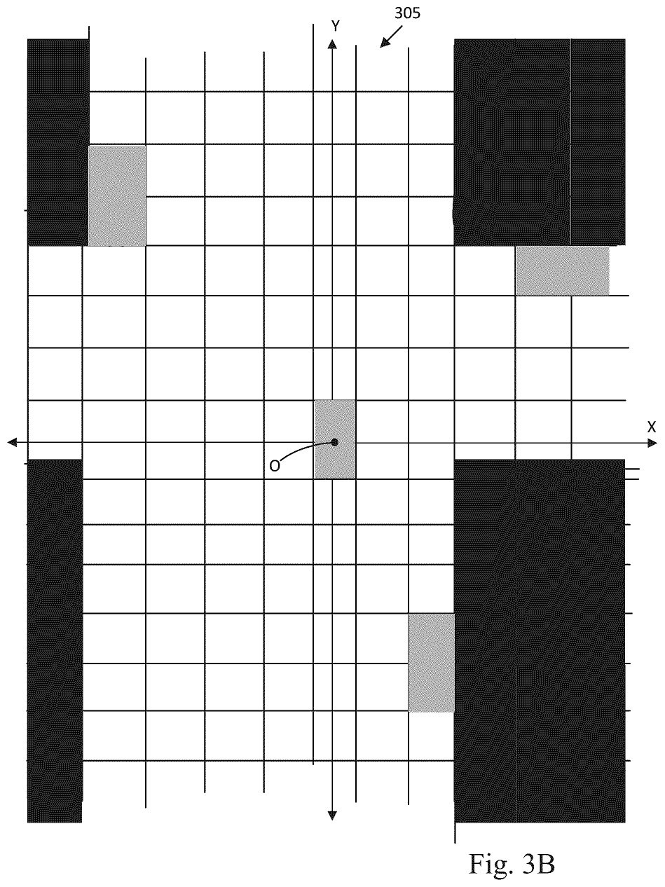

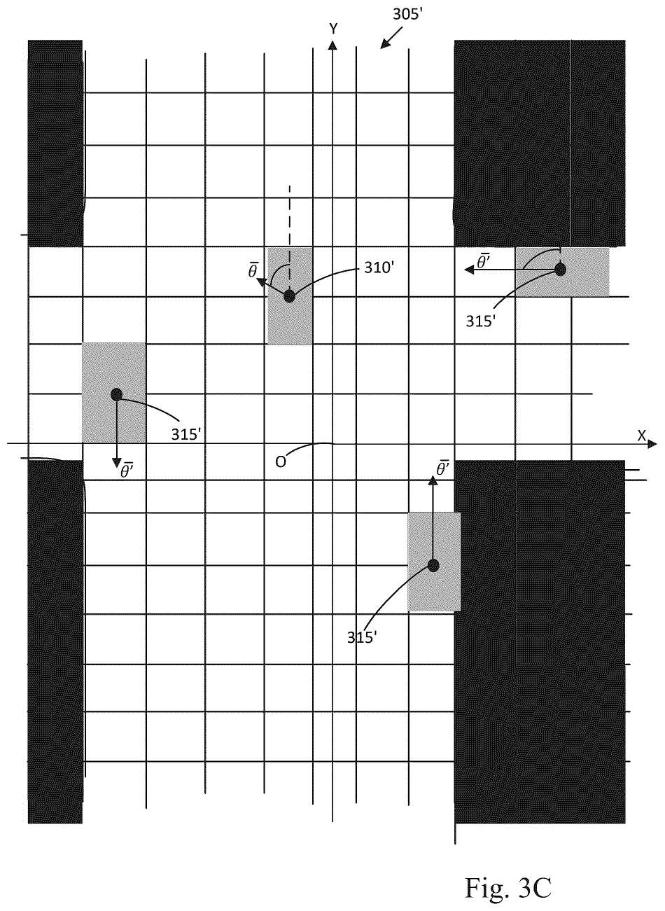

The computer 155, 160 can generate an occupancy grid map 300 for the area 205 based on the collected data of the host vehicle 105 and the collected data of the target vehicles 165, as shown in FIG. 3A. The computer 155, 160 can generate the occupancy grid map 300 based additionally on the map data for the area 205 and/or the infrastructure sensor 145 data. The computer 155, 160 may store (e.g., in a memory thereof) the occupancy grid map 300. The computer 155, 160 can be programmed to transmit the occupancy grid map 300 to the vehicle computer 110 (e.g., via the network 135).

The occupancy grid map 300 may be a dynamic occupancy grid map or a static occupancy grid map. A static occupancy grid map is an array or graph of grid cells that model occupancy (i.e., data showing objects and/or environmental features) of respective locations of the environment. A dynamic occupancy grid map is a static occupancy grid map that further includes kinematic attributes (i.e., data describing velocity, turn-rate, etc.) of respective grid cells. For illustration purposes, the occupancy grid map 300 is shown in a two-dimensional plane (e.g., an x-y plane); however, it should be understood that the occupancy grid map 300 could show in three-dimensional space (e.g., a Cartesian coordinate system defined by x, y, and z axes).

The sensor 115, 145 data can, for example, be provided in a two-dimensional plan (e.g., an x-y plane). As another example, the sensor 115, 145 data can be provided in a three-dimensional space (e.g., a Cartesian coordinate system defined by x, y, and z axes) and transformed into the two-dimensional plane (e.g., according to known coordinate system transformation techniques). Each grid cell corresponds to a location that is specified with respect to the global coordinate system. Each grid cell may be identified with a grid index x, y with respect to an origin of the global coordinate system. Each grid cell includes information regarding the presence or absence of an object in the respective grid cell of the occupancy grid map 300. An occupancy of a grid cell, i.e., whether an object or part of an object is detected in the cell, may be specified by a probability (or a percentage) that an object is detected in the grid cell (i.e., the grid cell is occupied). In the present illustration, the grid cells when displayed are shown as white (e.g., indicating that no object is detected or unoccupied) when the probability is less than a threshold (e.g., 50 percent), as grey (e.g., indicating that an object is present or occupied) when the probability is greater than or equal to the threshold, or as black (e.g., indicating that vehicle 105, 165 occupancy is not permitted (e.g., in cells corresponding to an area outside of roads). The threshold may be stored (e.g., in a memory of the computer 155, 160). Each grid cell may further include information regarding a velocity (e.g., a direction and a magnitude) in the respective grid cell of the occupancy grid map. A velocity may be represented with a color included in a color wheel or palette.

The vehicle computer 110 can identity collected data of the host vehicle 105. The collected data of the host vehicle 105 may be specified with respect to the vehicle coordinate system. The vehicle computer 110 can identify the collected data of the host vehicle 105 based on sensor 115 data. For example, the sensors 115 can capture data, e.g., image and/or video data, during operation of the host vehicle 105 in the area 205 and transmit the data to the vehicle computer 110. The vehicle computer 110 can then, for example, analyze the sensor 115 data (e.g., using pattern recognition and/or image analysis techniques) to identify the collected data of the host vehicle 105. As another example, the sensor 115 data can specify the collected data of the host vehicle 105 (e.g., wheel speed sensor 115 data specifying a speed of the host vehicle 105). The vehicle computer 110 can be programmed to transmit the collected data of the host vehicle 105 to the computer 155, 160 (e.g., via the network 135).

The vehicle computer 110 can obtain a portion 305 of the occupancy grid map 300 for the area 205, as shown in FIG. 3B. For example, upon receiving the occupancy grid map 300 from the computer 155, 160 (e.g., via the network 135), the vehicle computer 110 can segment the occupancy grid map 300 based on an area around the host vehicle 105 (i.e., remove a portion of the occupancy grid map 300 that encloses the host vehicle 105). A length and a width of the portion 305 may be predetermined and stored (e.g., in a memory of the vehicle computer 110). The length and the width may be determined empirically (e.g., based on determining a minimum area within which target vehicles 165 need to be accounted for when operating a host vehicle 105). The vehicle computer 110 can determine the portion 305 such that the host vehicle 105 is centered within the portion 305. That is, the host vehicle 105 can be positioned within the portion 305 such that the host vehicle 105 (i.e., a position thereof) bisects the length and the width of the portion 305 (i.e., the host vehicle 105 is equidistant from boundaries of the portion 305 defining the width of the portion 305 and is equidistant from boundaries of the portion 305 defining the length of the portion 305). The vehicle computer 110 can store (e.g., in a memory thereof) occupancy grid map 300 for the area 205. Alternatively, the computer 155, 160 can obtain the portion 305 and transmit the portion 305 to the vehicle computer 110 (e.g., via the network 135).

The vehicle computer 110 can be programmed to determine predicted data for the host vehicle 105 based on the collected data of the host vehicle 105. The predicted data includes, relative to the global coordinate system, a predicted position 310′ and a predicted heading angle θ̅ of the host vehicle 105. To determine the predicted data, the vehicle computer 110 generates a vehicle state matrix X(t) and a vehicle control matrix U(t) based on the collected data of the host vehicle 105 according to:

$$X ( t ) = {[ x ( t ) , y ( t ) , {v}_{x} ( t ) , {v}_{y} ( t ) ]}^{T} \qquad ( 1 )$$

$$U ( t ) = {[ {a}_{x} ( t ) , {a}_{y} ( t ) , Δθ ( t ) ]}^{T} \qquad ( 2 )$$

where x(t) is a location of the center of gravity of the host vehicle 105 relative to an x-axis in the global coordinate system, y(t) is a location of the center of gravity of the host vehicle 105 relative to an y-axis in the global coordinate system, vₓ(t) and v_{y}(t) are x and y components of the velocity of the host vehicle 105 relative to the global coordinate system, aₓ(t) and a_{y}(t) are x and y components of the acceleration of the host vehicle 105 relative to the global coordinate system, Δθ(t) is a change in the heading angle of the host vehicle 105 relative to the global coordinate system, and the superscript T is the transpose operator.

A prediction system 400 can determine the predicted position 310′ by solving a state function given by:

$$X ( t + 1 \vert t ) = X ( t \vert t ) + f ( X ( t \vert t ) , U ( t ) ) \qquad ( 3 )$$

where X(t+1|t) is a predicted vehicle state matrix at time t+1 given the vehicle state matrix at time t, and f(X(t|t), U(t)) is a state transition function.

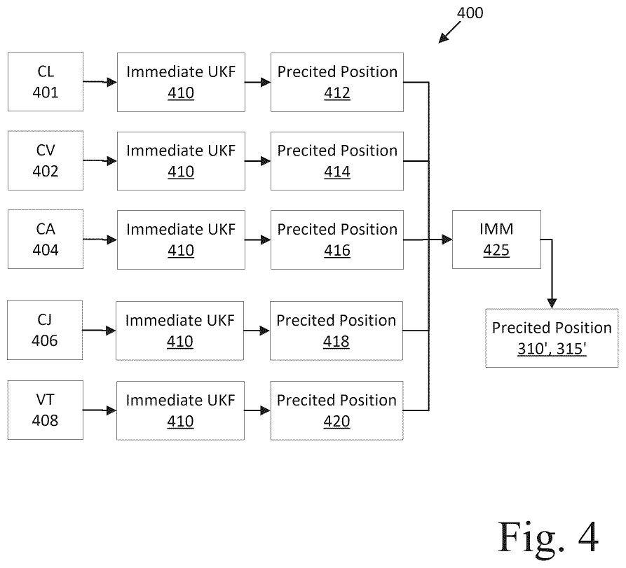

The prediction system 400 can be a software program executing on the vehicle computer 110. As shown in FIG. 4, the prediction system 400 includes five vehicle motion models 401, 402, 404, 406, 408 defined by respective vehicle control matrices U(t) and respective state transition functions f(X(t|t),U(t)). The motion models include a constant location (CL) model 401 (see Equation 4 below), a constant velocity (CV) model 402 (see Equation 5 below), a constant acceleration (CA) model 404 (see Equation 6 below), a constant jerk (CJ) (i.e., a rate of change of acceleration) model 406 (see Equation 7 below), and a vehicle turning (VT) model 408 (see Equation 8 below):

$$U ( t ) = {[ 0 , 0 , 0 ]}^{T} \qquad ( 4 )$$

$$f ( X ( t \vert t ) , U ( t ) ) = {[ 0 , 0 , 0 , 0 ]}^{T}$$

$$U ( t ) = {[ 0 , 0 , 0 ]}^{T} \qquad ( 5 )$$

$$f ( X ( t \vert t ) , U ( t ) ) = {[ {v}_{x} ( t ) \times Δ t , {v}_{y} ( t ) \times Δ t , 0 , 0 ]}^{T}$$

$$U ( t ) = {[ {a}_{x} ( t ) , {a}_{y} ( t ) , Δθ ( t ) ]}^{T} \qquad ( 6 )$$

$$f ( X ( t \vert t ) , U ( t ) ) = ( \begin{matrix}{v}_{x} ( t ) \times Δ t + \frac{1}{2} \times {a}_{x} ( t ) \times Δ {t}^{2} \\ {v}_{y} ( t ) \times Δ t + \frac{1}{2} \times {a}_{y} ( t ) \times Δ {t}^{2} \\ {a}_{x} ( t ) \times Δ t \\ {a}_{y} ( t ) \times Δ t\end{matrix} )$$

$$U ( t ) = {[ {a}_{x} ( t ) + {j}_{x} ( t ) \times Δ t , {a}_{y} ( t ) + {j}_{y} ( t ) \times Δ t , Δθ ( t ) ]}^{T} \qquad ( 7 )$$

$$f ( X ( t \vert t ) , U ( t ) ) = ( \begin{matrix}{v}_{x} ( t ) \times Δ t + \frac{1}{2} \times {a}_{x} ( t ) \times Δ {t}^{2} + \frac{1}{6} \times {j}_{x} ( t ) \times Δ {t}^{3} \\ {v}_{y} ( t ) \times Δ t + \frac{1}{2} \times {a}_{y} ( t ) \times Δ {t}^{2} + \frac{1}{6} \times {j}_{y} ( t ) \times Δ {t}^{3} \\ {a}_{x} ( t ) \times Δ t + \frac{1}{2} \times {j}_{x} ( t ) \times Δ {t}^{2} \\ {a}_{y} ( t ) \times Δ t + \frac{1}{2} \times {j}_{y} ( t ) \times Δ {t}^{2}\end{matrix} )$$

$$U ( t ) = {[ 0 , 0 , Δθ ( t ) ]}^{T} \qquad ( 8 )$$

$$f ( X ( t \vert t ) , U ( t ) ) = ( \begin{matrix}{v}_{x} ( t ) cos ( Δθ ( t ) ) + {v}_{y} ( t ) sin ( Δθ ( t ) ) Δ t \\ {v}_{y} ( t ) cos ( Δθ ( t ) ) - {v}_{x} ( t ) sin ( Δθ ( t ) ) Δ t \\ {v}_{x} ( t ) ( cos ( Δθ ( t ) ) - 1 ) + {v}_{y} ( t ) sin ( Δθ ( t ) ) \\ {v}_{y} ( t ) ( cos ( Δθ ( t ) ) - 1 ) - {v}_{x} ( t ) sin ( Δθ ( t ) )\end{matrix} )$$

where Δt is a timestep (i.e., an amount of time) between a current timestamp and a future timestamp at which the vehicle state matrix will be predicted. The timestep Δt may be a predetermined duration (e.g., 10 milliseconds, 1 second, 10 seconds, etc.) The timestep Δt may be stored (e.g., in a memory of the vehicle computer 110.)

The prediction system 400 can determine respective predicted positions 412, 414, 416, 418, 420 of the host vehicle 105 for the respective vehicle motion models 401, 402, 404, 406, 408. The prediction system 400 can input the respective vehicle motion models 401, 402, 404, 406, 408 given the vehicle state matrix X(t) and the vehicle control matrix U(t) into an Immediate Unscented Kalman Filter (UKF) 410. The Immediate UKF 410 works by forming a feedback loop between a prediction step, i.e., predicting the host vehicle 105 position and uncertainty value estimates for a next time step using prediction equations, and a measurement step, i.e., adjusting the predictions with measurements from the sensors 115 using measurement equations. The Immediate UKF 410 then outputs a predicted vehicle position 412, 414, 416, 418, 420 for the respective vehicle motion model 401, 402, 404, 406, 408 and a position uncertainty value for the respective vehicle motion model 401, 402, 404, 406, 408.

The state transition function is updated to consider measurement and process noise:

$$X ( t + 1 ) = F [ X ( t ) , q ( t ) , t ] \qquad ( 9 )$$

$$Z ( t ) = H [ ( X ( t ) , w ( t ) , t ]$$

where F[X(t)] represents a state function predicting a respective vehicle position 412, 414, 416, 418 from a respective current vehicle 105 position for the respective vehicle motion model 401, 402, 404, 406, 408, q(t) is a function defining the process noise, H[X(t)] represents an observation function updating a respective previous predicted vehicle 105 position based on the respective current vehicle 105 position, and w(t) is a function defining the measurement noise.

The initialization equations of the Immediate UKF 410 are:

$${\hat{x}}_{0} = E [ {x}_{0} ] \qquad ( 10 )$$

$${P}_{0} = E [ ( {x}_{0} - {\hat{x}}_{0} ) {( {x}_{0} - {\hat{x}}_{0} )}^{T} ]$$

where E is a mathematical expectation (i.e., a generalization of a weight average). Therefore, \hat{x}₀ is the mathematical expectation of x₀ (i.e., the current vehicle 105 state), and P₀ is the variance (i.e., an uncertainty value of the current vehicle 105 state).

To predict the host vehicle 105 position 412, 414, 416, 418, 420 for a respective vehicle motion model 401, 402, 404, 406, 408, the state transition function is instantiated at each point (i.e., a vehicle 105 state at which the state transition function is applied to predict a future vehicle 105 state) to derive a set of transformed sigma points according to:

$${X}_{i} ( t + 1 \vert t ) = F [ {X}_{i} ( t ) , U ( t ) ] , i = 0 , ... 2 L \qquad ( 11 )$$

where F[⋅] represents the state transition model of the respective vehicle motion model, and 2L is a number of states to which the current vehicle 105 state can transition.

The respective predicted vehicle positions 412, 414, 416, 418 for the respective vehicle motion models 401, 402, 404, 406, 408 can then be determined according to:

$$\hat{x} ( t + 1 \vert t ) = {\sum }_{i = 0}^{i = 2 L} {W}_{i}^{m} {X}_{i} ( t + 1 \vert t ) \qquad ( 12 )$$

Where W^{m} is a weight for the predicted mean state Xᵢ.

The covariance of the respective predicted vehicle positions 412, 414, 416, 418 for the respective vehicle motion models 401, 402, 404, 406, 408 is determined according to:

$${{P}_{xx} ( t + 1 \vert t ) = {\sum }_{i = 0}^{i = 2 L} {W}_{i}^{c} \{ [ {X}_{i} ( t + 1 \vert t ) - \hat{x} ( t + 1 \vert t ) ] \times [ {X}_{i} ( t + 1 \} t ) - \hat{x} ( t + 1 \vert t ) ]}^{T} \} + Q ( t \vert t ) \qquad ( 13 )$$

where Q(t|t) is the covariance of q(t), and W^{c} is a weight for the covariance.

The measurement equations of the Immediate UKF 410 are instantiated according to:

$${Z}_{i} ( t ) = H [ {X}_{i} ( t ) ] , i = 0 , ... 2 L \qquad ( 14 )$$

An observation mean is then determined according to:

$$\hat{z} ( t ) = {\sum }_{i = 0}^{i = 2 L} {W}_{i}^{m} {Z}_{i} ( t ) \qquad ( 15 )$$

A validation region represents a range of valid observation values. The validation region is defined according to:

$${Φ}_{i} ( t , {ϵ}^{2} ) = \{ v {: [ {Z}_{i} ( t ) - \hat{z} ( t ) ]}^{T} \times {[ {P}_{zz}^{i} ( t \vert t ) ]}^{- 1} \times [ {Z}_{i} ( t ) - \hat{z} ( t ) ] \leq {ϵ}^{2} \} \qquad ( 16 )$$

where ϵ is a parameter corresponding to a number of sigma points, v is the valid observation values, and P_{zz} is the covariance matrix determined according to:

$${P}_{zz} ( t ) = {\sum }_{i = 0}^{i = 2 L} {W}_{i}^{c} \{ [ {Z}_{i} ( t ) - \hat{z} ( t ) ] \times {[ {Z}_{i} ( t ) - \hat{z} ( t ) ]}^{T} \} + R ( t ) \qquad ( 17 )$$

where R(t) is the covariance of w(t). The source of the measuring noise covariance (i.e., uncertainty) is temporal and spatial asynchrony error when transmitting messages between communication nodes (e.g., via the network 135).

A near-optimal Kalman gain can be calculated as:

$$K ( t ) = {P}_{x z} ( t \vert t - 1 ) \times {P}_{zz}^{- 1} ( t ) \qquad ( 18 )$$

with a cross correlation matrix:

$${P}_{x z} ( t \vert t - 1 ) = {\sum }_{i = 0}^{i = 2 L} {W}_{i}^{c} \{ [ {X}_{i} ( t \vert t - 1 ) - \hat{x} ( t \vert t - 1 ) ] \times {[ {Z}_{i} ( t ) - \hat{z} ( t ) ]}^{T} \} \qquad ( 19 )$$

The respective predicted vehicle positions 412, 414, 416, 418 for the respective vehicle motion models 401, 402, 404, 406, 408 and the respective position uncertainties are therefore represented as:

$$\hat{x} ( t ) = \hat{x} ( t - 1 ) + K ( t ) \times ( Z ( t ) - \hat{z} ( t ) ) \qquad ( 20 )$$

$${P}_{x x} ( t ) = {P}_{x x} ( t - 1 ) + K ( t ) \times {P}_{zz}^{- 1} ( t ) \times {K ( t )}^{T}$$

The vehicle computer 110 can then input the respective predicted vehicle positions 412, 414, 416, 418 for the respective vehicle motion models 401, 402, 404, 406, 408 into an Interactive Multiple Model (IMM) 425. The IMM 425 determines transition probabilities of the respective vehicle motion models 401, 402, 404, 406, 408 at each iteration and outputs the predicted vehicle position 310′ based on the transition probabilities. The IMM 425 defines a set of the vehicle motion models 401, 402, 404, 406, 408 analyzed according to the Immediate UKF 410:

$$M = \{ {M}_{C L}^{U K F} , {M}_{C V}^{U K F} , {M}_{C A}^{U K F} , {M}_{CJ}^{U K F} , {M}_{V T}^{U K F} \} \qquad ( 21 )$$

where

$${M}_{C L}^{U K F}$$

is the constant location model 401 defined by Equation 4,

$${M}_{C V}^{U K F}$$

is the constant velocity model 402 defined by Equation 5,

$${M}_{C A}^{U K F}$$

is the constant acceleration model 404 defined by Equation 6,

$${M}_{V T}^{U K F}$$

is the constant jerk model 406 defined by Equation 7, and

$${M}_{CJ}^{U K F}$$

is the vehicle turning model 408 defined by Equation 8.

The IMM 425 works by applying the Markov model so that a probability of transitioning between states at a particular moment depends only on a preceding state. According to the Markov model, a probability of transitioning between vehicle motion models 401, 402, 404, 406, 408 is defined as:

$${p}_{i j} {=}^{△} p ( {M}_{j} ( t + 1 ) \vert {M}_{i} ( t ) ) , i , j ∈ \{ CL , CV , CA , CJ , VT \} \qquad ( 22 )$$

where 0<pᵢⱼ<1, and the sum of pᵢⱼ over all j (j∈{CL, CV, CA, CJ, VT}) equals one (1).

In the Markov model, given an initial state, the system will reach a stable state. This is achieved by iteratively computing probability updates until the stable state is achieved. Assuming an initial probability of:

$${μ}_{r} ( 0 ) = p ( {M}_{r} ( 0 ) ) , r ∈ \{ CL , CV , CA , CJ , VT \} \qquad ( 23 )$$

and iteratively computing the initial probability according to the IMM 425 converges to a value representing the probability transition matrix.

The IMM 425 computes a mixing probability according to:

$${μ}_{ij} ( t + 1 ) = \frac{1}{{\overline{c}}_{j}} {p}_{\dot{l} j} {μ}_{i} ( t ) , i , j ∈ \{ CL , CV , CA , CJ , VT \} \qquad ( 24 )$$

$$\overline{{c}_{j}} = {\sum }_{i} {p}_{i j} {μ}_{i} ( t )$$

An initial mixing state \tilde{x}ⱼ(t) and a corresponding mixing error covariance \tilde{P}ⱼ(t) are then determined based on the mixing probability according to:

$${\tilde{x}}_{j} ( t ) = {\sum }_{i} {μ}_{i j} ( t ) {\hat{x}}_{i} ( t ) , i , j ∈ \{ CL , CV , CA , CJ , VT \} \qquad ( 25 )$$

$${\tilde{P}}_{j} ( t ) = {\sum }_{i} {μ}_{ij} ( t ) ( {P}_{i} ( t ) + ( {\hat{x}}_{i} ( t ) - {\tilde{x}}_{j} ( t ) ) {( {\hat{x}}_{i} ( t ) - {\tilde{x}}_{j} ( t ) )}^{T} )$$

$$( {\hat{x}}_{i} ( t + 1 ) , {P}_{i} ( t + 1 ) ) = {ℱ}_{i} ( {\tilde{x}}_{i} ( t ) , {\tilde{P}}_{i} ( t ) )$$

where [symbol] ᵢ represents a function of a filter output for the model i, \hat{x}ᵢ(t) is a filter output state, and Pᵢ(t) is a covariance corresponding to the filter output state \hat{x}ᵢ(t) at timestamp t.

A probability update μᵢ(t+1) for model i at timestamp t+1 can be determined from a likelihood function Λᵢ according to:

$$\begin{matrix}{μ}_{i} ( t + 1 ) = \frac{1}{c} {Λ}_{i} ( t + 1 ) {\overline{c}}_{i} \\ c = {\sum }_{i} {Λ}_{i} ( t + 1 ) {\hat{x}}_{i} ( t + 1 )\end{matrix} \qquad ( 26 )$$

where c is a normalization constant.

The predicted vehicle position 310′ and the position uncertainty value can then be obtained according to:

$$\begin{matrix}\begin{matrix}\hat{x} ( t + 1 ) = {\sum }_{i} {μ}_{j} ( t + 1 ) {\hat{x}}_{i} ( t + 1 ) , & i , j ∈ \{ CL , CV , CA , CJ , VT \}\end{matrix} \\ P ( t + 1 ) = {\sum }_{i} {μ}_{i} ( t + 1 ) \times \{ {P}_{i} ( t + 1 ) + [ {\hat{x}}_{i} ( t + 1 ) - \hat{x} ( t + 1 ) ] \times {[ {\hat{x}}_{i} ( t + 1 ) - \hat{x} ( t + 1 ) ]}^{T} \}\end{matrix} \qquad ( 27 )$$

To determine the predicted heading angle θ̅ of the host vehicle 105, the vehicle computer 110 can input the predicted vehicle position 310′ to a vehicle dynamics model. The “vehicle dynamics model” is a kinematic model describing vehicle motion that outputs the predicted heading angle θ̅ according to a bicycle model. The predicted vehicle position 310′ is input to the bicycle model as the center of gravity in the global coordinate system, which is located at distances c and d from the front and rear wheels, respectively. This allows for deriving the following:

$$\begin{matrix}\frac{sin ( \frac{π}{2} - α )}{{r}_{G}} = \frac{sin ( α - β )}{c} , & \frac{sin ( \frac{π}{2} )}{{r}_{G}} = \frac{sin ( β )}{d}\end{matrix} \qquad ( 28 )$$

where β is a turn angle of the host vehicle 105, r_{G} is a radius of a path of the host vehicle 105, and α is an angle of the front wheels relative to a longitudinal axis of the host vehicle 105.

Rearranging equation 28 leads to:

$$tan α cos β = \frac{c + d}{{r}_{G}} \qquad ( 29 )$$

The turn angle β can then be determined by:

$$β = {tan}^{- 1} ( \frac{d tan α}{c + d} ) \qquad ( 30 )$$

The predicted heading angle θ̅ can then be determined from the turning angle β and the current heading angle θ according to:

$$\overline{θ} = θ + {tan}^{- 1} ( \frac{d tan α}{c + d} ) \qquad ( 31 )$$

The vehicle computer 110 can be further programmed to determine predicted data (i.e., a predicted position 315′ and a predicted heading angle θ̅′) for the target vehicles 165 in the same manner as just described. Alternatively, the computer 155, 160 can determine the predicted data for the host vehicle 105 and/or the predicted data for the target vehicles 165 in the same manner as just described. In this situation, the computer 155, 160 may be programmed to transmit the predicted data for the host vehicle 105 and/or the predicted data for the target vehicles 165 to the vehicle computer 110 (e.g., via the network 135).

Upon determining the predicted data for the host vehicle 105 and the target vehicles 165, the vehicle computer 110 can generate a predicted portion 305′ of the occupancy grid map 300 for the area 205, as shown in FIG. 3C. The vehicle computer 110 can insert respective unit vectors into a grid cell such that respective initial points of the respective vectors are the respective predicted positions 310′, 315′ of the respective vehicles 105, 165. Respective directions of the respective unit vectors are the respective predicted heading angles θ̅, θ̅′ of the respective vehicles 105, 165. The vehicle computer 110 can then determine a predicted occupancy of the portion 305′ based on respective sizes (e.g., a length and a width) of the host vehicle 105 and the target vehicles 165. The vehicle computer 110 can generate respective two-dimensional (2D) boxes based on the respective sizes of the respective vehicles 105, 165 and can center the respective 2D boxes on the respective predicted positions 310′ 315′ (i.e., aligning the respective 2D boxes with the respective predicted positions 310′, 315′ such that the respective predicted positions 310′, 315′ bisect the respective widths and respective lengths of the respective 2D boxes). In this way, the respective 2D boxes occupy grid cells corresponding to the respective predicted positions 310′, 315′ of the respective vehicles 105, 165. Alternatively, the computer 155, 160 can generate the predicted portion 305′ of the occupancy grid map 300 in the same manner as just described. In this situation, the computer 155, 160 may be programmed to transmit the predicted portion 305′ to the vehicle computer 110 (e.g., via the network 135).

The vehicle computer 110 can then input the portion 305 and the predicted portion 305′ of the occupancy grid map 300 to a deep reinforcement learning (DRL) agent 500 that outputs an action (ACT) 512, for example, as shown in Table 1.

TABLE 1

| Action | Control Parameter Change |
|---|---|
| Maintain Current State | velocity v = v; |
| | heading angle θ = θ |
| Longitudinally Accelerate | Acceleration a = +1 m/s² |
| Longitudinally Decelerate | acceleration a = −1 m/s² |
| Turn Left | Steering angle α = −π/6 rad |
| Turn Right | Steering angle α = +π/6 rad |

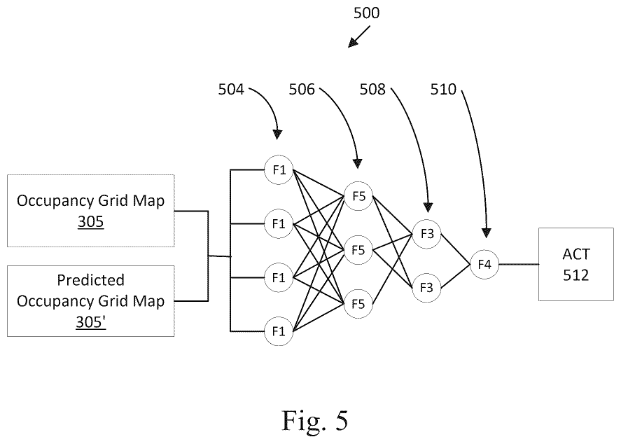

As shown in FIG. 5, the DRL agent 500 includes layers 504, 506, 508, 510 that include fully connected processing neurons F1, F2, F3, F4. Each processing neuron is connected to either an input value or output from one or more neurons F1, F2, F3 in a preceding layer 504, 506, 508. Each neuron F1, F2, F3, F4 can determine a linear or non-linear function of the inputs and output the result to the neurons F2, F3, F4 in a succeeding layer 506, 508, 510. A DRL agent 500 is trained by determining a reward function based on the output and inputting the reward function to the layers 504, 506, 508, 510. The reward function is used to determined weights that govern the linear or non-linear functions determined by the neurons F1, F2, F3, F4.

An output state matrix of the host vehicle 105 is determined based on the action 512 output by the DRL agent 500. If the action 512 is to maintain the current state, then the output state matrix of the host vehicle 105 is determined according to:

$$( \begin{matrix}\overline{x} \\ \overline{y} \\ {\overline{v}}_{x} \\ {\overline{v}}_{y} \\ \overline{θ}\end{matrix} ) = ( \begin{matrix}x + {v}_{g} sin ( θ ) \times Δ t \\ y + {v}_{g} cos ( θ ) \times Δ t \\ {v}_{g} sin ( θ ) \\ {v}_{g} cos ( θ ) \\ θ\end{matrix} ) \qquad ( 32 )$$

where x and y are the global coordinates of the center of gravity the host vehicle 105 and vg is a velocity vector located at the center of gravity of the host vehicle 105 (centers of gravity can be defined, for example, according to manufacturer specifications).

If the action 512 is to longitudinally accelerate or longitudinally decelerate, then the output state matrix of the host vehicle 105 is determined according to:

$$( \begin{matrix}\overline{x} \\ \overline{y} \\ {\overline{v}}_{x} \\ {\overline{v}}_{y} \\ \overline{θ}\end{matrix} ) = ( \begin{matrix}x + {\overline{v}}_{g} sin ( θ ) \times Δ t \\ y + {\overline{v}}_{g} cos ( θ ) \times Δ t \\ {\overline{v}}_{g} sin ( θ ) \\ {\overline{v}}_{g} cos ( θ ) \\ θ\end{matrix} ) \qquad ( 33 )$$

$$with :$$

$${\overline{v}}_{g} = {v}_{g} + a \times Δ t \qquad ( 34 )$$

If the action 512 is to turn the host vehicle 105, then the output state matrix of the host vehicle 105 is determined according to:

$$( \begin{matrix}\overline{x} \\ \overline{y} \\ {\overline{v}}_{x} \\ {\overline{v}}_{y} \\ \overline{θ}\end{matrix} ) = ( \begin{matrix}x + {v}_{g} sin ( \overline{θ} ) \times Δ t \\ y + {v}_{g} cos ( \overline{θ} ) \times Δ t \\ {v}_{g} sin ( \overline{θ} ) \\ {v}_{g} cos ( \overline{θ} ) \\ θ + {tan}^{- 1} ( \frac{b tan α}{a + b} )\end{matrix} ) \qquad ( 33 )$$

The vehicle computer 110 operates the host vehicle 105 based on the output state matrix. For example, the vehicle computer 110 can input the output state matrix to a motion control algorithm that outputs one or more control parameters. The vehicle computer 110 can then actuate one or more vehicle components 125 according to the control parameters. A “motion control algorithm” is a control algorithm that outputs one or more control parameters based on inputs of one or more vehicle states. The motion control algorithm can be, e.g., a model predictive control algorithm, a linear-quadratic regulator algorithm, a full state feedback control algorithm, a partial state feedback control algorithm, or a pole placement algorithm.

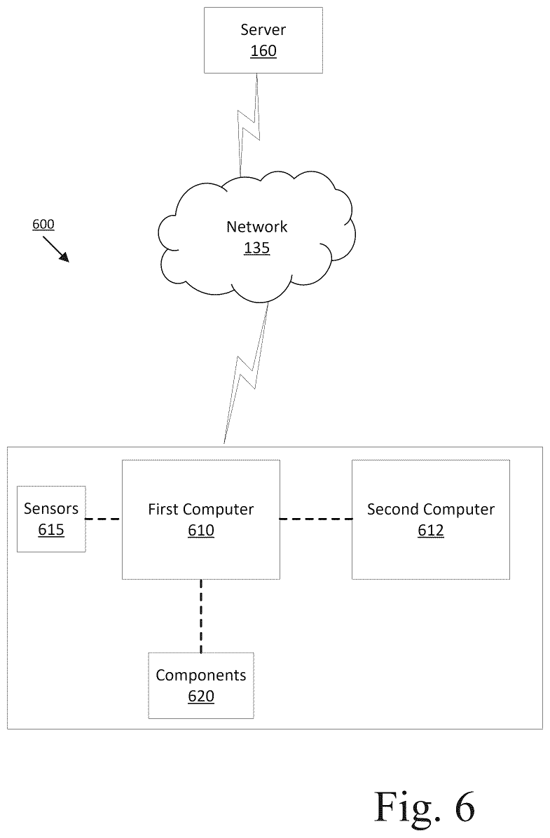

With reference to FIG. 6, an example simulation system 600 includes a first computer 610 and a second computer 612 communicatively connected to each other. The simulation system 600 can simulate operating conditions of a vehicle.

The simulation system 600 may include hardware and software such as is known (or could be a system developed or built in the future). The simulation system 600 may include sensors 615 and vehicle components 620 comprising a vehicle subsystem, e.g., the powertrain subsystem, the braking subsystem, the steering subsystem, etc. As discussed further below, the simulation system 600 can simulate operation of a virtual vehicle and/or physical vehicle components 620. The computers 610, 612 are generally arranged for communications on a communication network that can include a controller area network (CAN) or the like, and/or other wired and/or wireless mechanisms. Via the communication network, the computers 610, 612 may receive messages (e.g., CAN messages) from the various devices (e.g., sensors 615) in the simulation system 600. For example, the sensors 615 may provide the computer 610 with data about the components 620 being used for simulation. As mentioned below, various controllers and/or sensors 615 may provide data to the computers 610, 612 via the communication network. Additionally, the computers 610, 612 may transmit messages to the remote server computer 160 (e.g., via the network 135).

The computer 610 can collect and process data about the vehicle components 620 being used for simulation. Based on the data, the computer 610 can actuate the vehicle components 620 during the simulation. For example, the vehicle subsystem being simulated can be the powertrain subsystem, a brake subsystem, a steering subsystem, etc. In these circumstances, the computer 610 can be a powertrain controller, a brake controller, a steering controller, etc. The computer 610 can control operation of the vehicle components 620 of the vehicle subsystem being simulated. For example, the operation can be controlling steering, controlling braking, controlling a human-machine interface, etc. The computer 610 may be an electronic control unit (ECU). An “electronic control unit” (ECU) is a device including a processor and a memory that includes programming (i.e., the memory stores instructions executable by the processor) to control one or more vehicle components 620.

Sensors 615 can include a variety of devices. For example, various controllers in a simulation system 600 may operate as sensors 615 to provide data via wired communication, e.g., data relating to subsystem and/or component status, to the computer 610. Further, other sensors 615 could include cameras, motion detectors, etc., i.e., sensors 615 to provide data for evaluating a position of a component, a condition of a component, etc. The sensors 615 could, without limitation, also include radar, LIDAR, and/or ultrasonic transducers.

The simulation system 600 can simulate one or more actual (i.e., physical) vehicle components 620. For example, the simulation system 600 can include each vehicle component 620 of a vehicle powertrain subsystem and a steering subsystem. As another example, the simulation system 600 can include vehicle components 620 constituting a portion of one or more vehicle subsystems. In this context, each vehicle component 620 includes one or more hardware components adapted to perform a mechanical function or operation-such as moving the vehicle, slowing or stopping the vehicle, steering the vehicle, etc. Non-limiting examples of components 620 include a propulsion component (that includes, e.g., an internal combustion engine and/or an electric motor, etc.), a transmission component, a steering component (e.g., that may include one or more of a steering wheel, a steering rack, etc.), a brake component, or the like.

As another example, the simulation system 600 can simulate a virtual vehicle. In such an example, the first computer 610 can input a virtual vehicle into a vehicle dynamics model. The “vehicle dynamics model” is a physics-based kinematic or dynamic model describing vehicle motion that outputs respective vehicle states according to various control parameters. The vehicle dynamics model can model and output performance of the virtual vehicle (or one or more components thereof) actuated to move according to an action 512 output from the DRL agent 500. By inputting the virtual vehicle to the vehicle dynamics model, the vehicle computer 610 can obtain data specifying respective vehicle states while operating the virtual vehicle according to the various actions 512. That is, the first computer 610 can simulate operation of the virtual vehicle in various conditions. In this situation, the vehicle computer 610 can determine whether output of the vehicle system is within a control parameter.

The second computer 612 can simulate operation of an infrastructure element 140. The second computer 612 can select a scenario from a plurality of scenarios. A scenario is a set of data including simulated data for virtual vehicles operating in a virtual area, map data for the virtual area, SPAT data for virtual traffic signals in the virtual area, and a simulated occupancy grid map for the virtual area. The second computer 612 can select the scenario from a database, or the like, that stores various possible scenarios. The second computer 612 can access the database (e.g., stored in a memory of the second computer 612) to iteratively or sequentially execute the scenarios until the DRL agent 500 is trained for each scenario. Upon selecting the scenario, the second computer 612 can provide the selected scenario to the first computer 610.

The first computer 610 can obtain a portion of a simulated occupancy grid map based on the simulated data specified in the selected scenario in the same manner as described above regarding obtaining a portion 305 of an occupancy grid 300 for an area 205. Additionally, the first computer 610 can generate a predicted portion of the simulated occupancy grid map by predicting simulated data for the virtual vehicles via the prediction system 400 (i.e., based on inputting the simulated data to the Immediate UKF 410 and the IMM 425 algorithms), as described above.

The first computer 610 is programmed to train the DRL agent 500 to maximize a potential future reward. A DRL agent 500 is a machine learning program that combines reinforcement learning and deep neural networks. Reinforcement learning is a process whereby an DRL agent 500 learns how to behave in its environment by trial and error. The DRL agent 500 uses its current state as an input, and selects an action 512 to take. The action 512 results in the DRL agent 500 moving into a new state, and either being rewarded or penalized for the action it took. This process is repeated many times and by trying to maximize its potential future reward, a DRL agent 500 learns how to behave in its environment. Once the DRL agent 500 maximizes its potential future reward for each scenario provided by the second computer 612, the first computer 610 can provide the trained DRL agent 500 to the remote server computer 160 (e.g., via the network 135). The remote server computer 160 can then provide the trained DRL agent 500 to the vehicle computer 610 (e.g., via the network 135).

To determine the reward, the first computer 610 simulates operation of a virtual vehicle based on the action 512 output from the DRL agent 500 and compares the new state of the virtual vehicle to the scenario. As one example, the first computer 610 can determine the reward for a respective action 512 by comparing the new state of the DRL agent 500 to the simulated map data of the scenario (e.g., to determine a position of the DRL agent 500 relative to virtual roads in the scenario). As another example, the first computer 610 can determine the reward for a respective action 512 based on determining whether the action 512 corresponds to simulated SPAT data for the scenario (i.e., satisfies operating parameters indicated by a virtual traffic signal (i.e., whether to stop or continue operating a virtual vehicle based on a color of a light of the traffic signal)). As yet another example, the first computer 610 can determine the reward for a respective action 512 by comparing the new state of the DRL agent 500 to simulated predicted data of virtual target vehicles in the scenario (e.g., to determine whether the DRL agent 500 maintains a minimum distance from the respective virtual target vehicles).

A reinforcement learning problem can be expressed as a Markov Decision Process (MDP). An MDP consists of a 4-tuple (S, A, T, R), where S is the state space, A is the action space, T:S×A→S′ is the state transition function, and R:S×A×S′→ [symbol] is the reward function. The objective of the MDP is to find an optimal policy π* that maximizes the potential future reward:

$${π}^{*} = \begin{matrix}arg max \\ π\end{matrix} {R}^{π} = {r}_{0} + γ {r}_{1} + {γ}^{2} {r}_{2} + … \qquad ( 36 )$$

Where γ is a discount factor that discounts rewards rᵢ in the future. In DRL agent 500, a deep neural network is used to approximate the MDP, so that a state transition function is not required. This is useful when either the state space and/or the action space is large or continuous. The mechanism by which the deep neural network approximates the MDP is by minimizing the loss function at step i:

$${L}_{i} ( {w}_{i} ) = {𝔼}_{s , a , r , s ’} [ r + γ \begin{matrix}max \\ a ’\end{matrix} Q ( s ’ , a ’ , {w}^{-} ) - Q ( s , a , {w}_{i} ) ] \qquad ( 37 )$$

Where w are the weights of the neural network, s is the current state, a is the current action, r is the reward determined for the current action, s′ is the state reached by taking action a in state s, Q(s, a, wᵢ) is the estimate of the value of action a at state s, and [symbol] is the expected difference between the determined value and the estimated value. The weights of the neural network are updated by gradient descent.

$$Δ w = β ( r + γ \begin{matrix}max \\ a\end{matrix} \hat{q} ( {s}^{′} , a , \overline{w} ) - \hat{q} ( s , a , w ) ) {∇}_{w} \hat{q} ( s , a , w ) \qquad ( 38 )$$

Where β is the size of the step and w̅ is the fixed target parameter that is updated periodically, and ∇_{w}\hat{q}(s, a, w) is the gradient with respect to the weights w. Fixed target parameter w̅ is used instead of w in equation 37 is to enhance stability of the gradient descent algorithm.

The reward function R can be a weighted sum of reward components. During training, the first computer 610 can determine a reward for each action based on the new state of the DRL agent 500 according to the reward function R:

$$Rewards += [ \begin{matrix}\begin{matrix}- 500 \& + Terminated & if : exceed operating parameter or Max\end{matrix} \\ \begin{matrix}- 100 & if : predicted to exceed operating parameter\end{matrix} \\ \begin{matrix}( 200 - step ) {\sqrt{( goal}}_{num} + 1 ) & if : achieve shaped goal\end{matrix} \\ \begin{matrix}- 5 & if : occupied lane line\end{matrix} \\ \begin{matrix}- 1000 & if : terminated\end{matrix} \\ \begin{matrix}1000 & if : achieve final goal\end{matrix} \\ \begin{matrix}- 10 {( a )}^{2} & if : action is acceleration or deceleration\end{matrix}\end{matrix} \qquad ( 39 )$$

where step is an instance of the DRL agent 500 selecting an action 512, goalₙᵤₘ is an identifier for a shaped goal, and Max is a maximum number of steps that the DRL agent 500 is permitted to execute to achieve a final goal. The maximum number of steps may be stored (e.g., in a memory of the first computer 610). The maximum number of steps may be determined empirically (e.g., based on determining an amount of time available for the DRL agent 500 to output an action 512 and the number of steps that the DRL agent 500 can execute within the available amount of time).

Reward shaping may be employed to generate the reward function R such that the reward function R provides more frequent feedback. For example, the shaped reward function R may provide feedback regarding the new state of the DRL agent 500 achieving shaped (i.e., intermediate) goals prior to achieving a final goal. As one example, the shaped reward R can distribute the shaped rewards between a starting point of the virtual vehicle and a final goal. For steering straight operations (i.e., an action 512 that maintains a heading angle of the virtual vehicle), the shaped goals may extend across a width of the virtual lane in which the virtual vehicle is operating in the scenario. The shaped and/or final goals may be spaced a uniform distance from each other along the lane (e.g., 20 meters). For turning operations (i.e., an action 512 that changes the heading angle of the virtual vehicle), the shaped goals are converted to polar coordinates according to:

$$\begin{matrix}\begin{matrix}{x}^{′} = x - w , & {y}^{′} = y - w\end{matrix} \\ {ρ}^{′} = \sqrt{{x}^{′2} + {y}^{′2}} \\ {θ}^{′} = {tan}^{- 1} ( \frac{{x}^{′}}{{y}^{′}} )\end{matrix} \qquad ( 40 )$$

where x and y are coordinates in the global coordinate system, x′ and y′ are transformed polar coordinates, w is half a width of a road, which results in ρ′ and θ′ being the polar radius and polar angle, respectively orientated with respect to a heading angle θ of the virtual vehicle 105.

A virtual turning area can then be determined according to the polar angle θ′ according to:

$$\begin{matrix}{ρ}_{m i n}^{′} = w \\ {ρ}_{ma x}^{′} = 2 w / cos {θ}^{′} \\ {θ}^{′} ∈ ( 0 , {tan}^{- 1} ( 1 / 2 ) )\end{matrix} \qquad ( 41 )$$

$$\begin{matrix}{ρ}_{min}^{′} = w \\ {ρ}_{ma x}^{′} = \sqrt{5} w \\ {θ}^{′} ∈ ( {tan}^{- 1} ( \frac{1}{2} ) , {tan}^{- 1} ( 2 ) )\end{matrix} \qquad ( 42 )$$

$$\begin{matrix}{ρ}_{min}^{′} = w \\ {ρ}_{ma x}^{′} = 2 w / sin {θ}^{′} \\ {θ}^{′} ∈ ( {tan}^{- 1} ( 2 ) , π / 2 )\end{matrix} \qquad ( 43 )$$

During the vehicle turning operation, the shaped goals can be placed at uniform intervals of the polar angle θ′ (e.g., π/8) and extend from the maximum to the minimum polar radius ρ′.

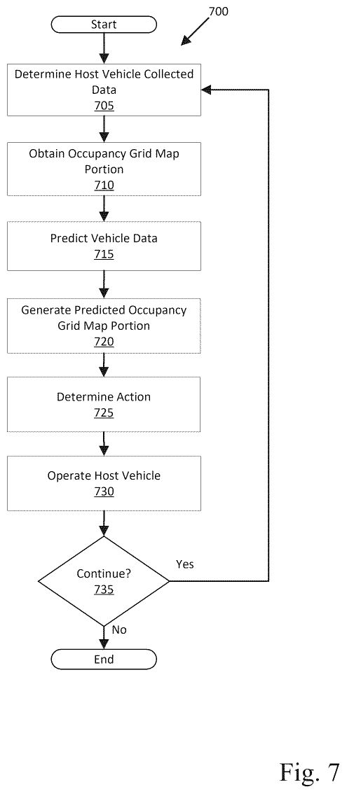

FIG. 7 is a diagram of an example process 700 for operating a vehicle. The process 700 begins in a block 705. The process 700 can be carried out by a vehicle computer 110 included in a host vehicle 105 executing program instructions stored in a memory thereof.

In the block 705, the vehicle computer 110 determines collected data of the host vehicle 105. For example, the vehicle computer 110 can obtain sensor 115 data during operation of the host vehicle 105. The vehicle computer 110 can then determine the collected data of the host vehicle 105 based on the sensor 115 data, as discussed above. The process 700 continues in a block 710.

In the block 710, the vehicle computer 110 obtains a portion 305 of an occupancy grid map 300 for the area 205. As one example, the vehicle computer 110 can receive the occupancy grid map 300 (e.g., via the network 135). The vehicle computer 110 can then segment the portion 305 such that the host vehicle 105 is centered within the portion 305, as described above. The process 700 continues in a block 715.

In the block 715, the vehicle computer 110 determines predicted data for the host vehicle 105 and predicted data for the respective target vehicles 165. For example, the vehicle computer 110 can input the collected data of the host vehicle 105 and respective vehicle motion models 401, 402, 404, 406, 408 into an Immediate UKF 410 that outputs respective predicted vehicle positions 412, 414, 416, 418, 420 for the respective motion models 401, 402, 404, 406, 408, as discussed above. The respective predicted vehicle positions 412, 414, 416, 418, 420 can then be input to an IMM 425 that outputs a predicted vehicle position 310, as discussed above. Additionally, the vehicle computer 110 can determine a predicted heading angle θ̅ for the host vehicle 105 based on inputting the predicted vehicle position 310 into a bicycle model, as discussed above. The vehicle computer 110 can determine the respective predicted vehicle positions 315 and the respective predicted heading angles θ̅′ for each of the respective target vehicles 165 in this manner. The process 700 continues in a block 720.

In the block 720, the vehicle computer 110 generates a predicted portion 305′ of the occupancy grid map 300 based on the predicted data for the host vehicle 105 and the predicted data for the respective target vehicles 165. For example, the vehicle computer 110 can predict occupancy of the portion 305′ based on the respective predicted vehicle positions 310, 315, the respective predicted heading angles θ̅, θ̅′, and respective vehicle 105, 165 sizes, as discussed above. The process 700 continues in a block 725.

In the block 725, the vehicle computer 110 determines an action 512. The vehicle computer 110 inputs the portion 305 and the predicted portion 305′ of the occupancy grid map 300 to a DRL agent trained to output the action 512, as discussed above. The process 700 continues in a block 730.

In the block 730, the vehicle computer 110 operates the host vehicle 105 based on the action 512. For example, the vehicle computer 110 can determine an output state matrix based on the action 512, as discussed above. The vehicle computer 110 can then input the output state matrix to a motion control algorithm that outputs one or more control parameters. The vehicle computer 110 can then actuate one or more vehicle components 125 based on the control parameter(s), as discussed above. The process 700 continues in a block 735.

In the block 735, the vehicle computer 110 determines whether to continue the process 700. For example, the vehicle computer 110 can determine not to continue when the host vehicle 105 is in an OFF state. Conversely, the vehicle computer 110 can determine to continue when the host vehicle 105 is in an ON state. If the vehicle computer 110 determines to continue, the process 700 returns to the block 705. Otherwise, the process 700 ends.

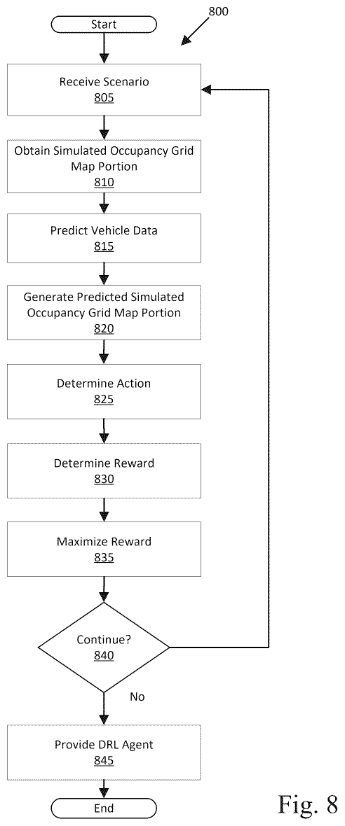

FIG. 8 is a diagram of an example process 800 for training the DRL agent. The process 800 begins in a block 805. The process 800 can be carried out by a first computer 610 included in a simulation system 600 executing program instructions stored in a memory thereof.

In the block 805, the first computer 610 receives a scenario from a second computer 112 included in the simulation system. The second computer 612 can select a scenario from a plurality of scenarios, as discussed above. The selected scenario includes simulated collected data of virtual vehicles operating in a virtual area, simulated SPAT data for virtual traffic signals in the virtual area, and simulated map data for the virtual area, as discussed above. The process 800 continues in a block 810.

In the block 810, the first computer 610 obtains a portion of the simulated occupancy grid map. The block 810 is substantially identical to the block 710 of the process 700 therefore will not be described further to prevent redundancy. The process 800 continues in a block 815.

In the block 815, the first computer 610 determines predicted data for the virtual vehicles. The block 815 is substantially identical to the block 715 of the process 700 therefore will not be described further to prevent redundancy. The process 800 continues in a block 820.

In the block 820, the first computer 610 generates a predicted portion of the simulated occupancy grid map based on the predicted data for the virtual vehicles. The block 820 is substantially identical to the block 720 of the process 700 therefore will not be described further to prevent redundancy. The process 800 continues in a block 825.

In the block 825, the first computer 610 determines an action 512 based on the portion and the predicted portion of the simulated occupancy grid map. The block 825 is substantially identical to the block 725 of the process 700 therefore will not be described further to prevent redundancy. The process 800 continues in a block 830.

In the block 830, the first computer 610 determines a reward based on a reward function. To determine the reward, the first computer 610 updates a state of the host virtual vehicle based on the action to achieve a new state. The first computer 610 can then compare the new state of the host virtual vehicle to the scenario to determine the reward (e.g., based on equation 36), as discussed above. The process 800 continues in a block 835.

In the block 835, the first computer 610 maximizes the reward. To maximize the reward, the first computer 610 finds an optimal policy that approximates an MDP is by minimizing a loss function, as discussed above. The process 800 continues in a block 840.

In the block 840, the first computer 610 determines whether to continue the process 800. For example, the first computer 610 can determine not to continue when the DRL agent 500 has been trained to maximize the reward for each scenario. Conversely, the first computer 110 can determine to continue upon determining that the DRL agent 500 requires training on one or more scenarios. If the first computer 610 determines to continue, the process 800 returns to the block 805. Otherwise, the process 800 ends.

Systems and methods described herein may be modified and/or omitted depending on the context, situation, and applicable rules and regulations. Further, regardless actions that may be taken by a vehicle such as a computer controlling vehicle speed and/or acceleration, users should use good judgement and common sense when operating the vehicle. Operations described herein should always be implemented and/or performed in accordance with the owner manual and safety guidelines.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor to:
obtain a portion of an occupancy grid map for an area, wherein the occupancy grid map is generated based on collected data of a host object in the area and collected data of respective target objects in the area;
generate a predicted portion of the occupancy grid map based on predicted data of the host object and predicted data of the respective target objects;
determine an action based on inputting the portion and the predicted portion of the occupancy grid map to a deep reinforcement learning neural network; and
operate the host object based on the action.

2. The system of claim 1, wherein the instructions further include instructions to receive the collected data of the respective target objects from an infrastructure element in the area.

3. The system of claim 1, wherein the instructions further include instructions to determine the collected data of the host object based on host object sensor data.

4. The system of claim 1, wherein the deep reinforcement learning neural network is trained based on a reward function, a reward for the reward function being determined based on comparing the action to a virtual scenario.

5. The system of claim 4, wherein the virtual scenario includes virtual target vehicles operating in a virtual area, simulated signal phase and timing (SPaT) data for virtual traffic signals in the virtual area and map data for the virtual area.

6. The system of claim 1, wherein the instructions further include instructions to:
upon inputting the collected data of the host object and respective motion models to an Immediate Unscented Kalman Filter, determine respective object positions for the respective motion models; and
determine a predicted host object position based on output from an Immediate Multiple Model that accepts the respective object positions for the respective motion models as input; and
determine, in the predicted occupancy grid map, a predicted occupancy of the host object based on the predicted host object position and a host object size.

7. The system of claim 6, wherein the instructions further include instructions to, upon determining a predicted heading angle of the host object based on the predicted host object position, determine the predicted occupancy of the host object additionally based on the predicted heading angle.

8. The system of claim 1, wherein the instructions further include instructions to:
upon inputting the collected data of each of the respective target objects and respective motion models to an Immediate Unscented Kalman Filter, determine respective target object positions for the respective motion models; and
for each of the respective target objects, determine a predicted target object position based on output from an Immediate Multiple Model that accepts the respective target object positions for the respective motion models as input; and
determine, in the predicted occupancy grid map, respective predicted occupancies of the respective target objects based on the respective predicted target object positions and respective target object sizes.

9. The system of claim 8, wherein the instructions further include instructions to, upon determining respective predicted heading angles for each of the respective target objects based on the respective predicted target object positions, predicted occupancy of the respective target objects additionally based on the respective predicted heading angles.

10. The system of claim 1, wherein the occupancy grid map is generated based additionally on at least one of signal phase and timing (SPaT) data for traffic signals in the area and map data for the area.

11. A method, comprising:
obtaining a portion of an occupancy grid map for an area, wherein the occupancy grid map is generated based on collected data of a host object in the area and collected data of respective target objects in the area;
generating a predicted portion of the occupancy grid map based on predicted data of the host object and predicted data of the respective target objects;
determining an action based on inputting the portion and the predicted portion of the occupancy grid map to a deep reinforcement learning neural network; and
operating the host object based on the action.

12. The method of claim 11, further comprising receiving the collected data of the respective target objects from an infrastructure element in the area.

13. The method of claim 11, further comprising determining the collected data of the host object based on host object sensor data.

14. The method of claim 11, wherein the deep reinforcement learning neural network is trained based on a reward function, a reward for the reward function being determined based on comparing the action to a virtual scenario.

15. The method of claim 14, wherein the virtual scenario includes virtual target vehicles operating in a virtual area, simulated signal phase and timing (SPaT) data for virtual traffic signals in the virtual area and map data for the virtual area.

16. The method of claim 11, further comprising:
upon inputting the collected data of the host object and respective motion models to an Immediate Unscented Kalman Filter, determining respective object positions for the respective motion models;
determining a predicted host object position based on output from an Immediate Multiple Model that accepts the respective object positions for the respective motion models as input; and
determining, in the predicted occupancy grid map, a predicted occupancy of the host object based on the predicted host object position and a host object size.

17. The method of claim 16, further comprising, upon determining a predicted heading angle of the host object based on the predicted host object position, determining the predicted occupancy of the host object additionally based on the predicted heading angle.

18. The method of claim 11, further comprising:
upon inputting the collected data of each of the respective target objects and respective motion models to an Immediate Unscented Kalman Filter, determining respective target object positions for the respective motion models; and
for each of the respective target objects, determining a predicted target object position based on output from an Immediate Multiple Model that accepts the respective target object positions for the respective motion models as input; and
determining, in the predicted occupancy grid map, respective predicted occupancies of the respective target objects based on the respective predicted target object positions and respective target object sizes.

19. The method of claim 18, further comprising, upon determining respective predicted heading angles for each of the respective target objects based on the respective predicted target object positions, determining the predicted occupancy of the respective target objects additionally based on the respective predicted heading angles.

20. The method of claim 11, wherein the occupancy grid map is generated based additionally on at least one of signal phase and timing (SPaT) data for traffic signals in the area and map data for the area.
